(19) United States
(12) Patent Application Publication
(10) Pub. No.: US 2026/0052612 A1
(43) Pub. Date: Feb. 19, 2026

(54) HIGHLY COMPATIBLE LIGHTING DEVICE DRIVER

(71) Applicant: Xiamen PVTECH Co., Ltd., Xiamen (CN)

(72) Inventors: RONGTU LIU, Xiamen (CN); FUXING LU, Xiamen (CN)

(73) Assignee: Xiamen PVTECH Co., Ltd., Xiamen (CN)

(21) Appl. No.: 19/012,883

(22) Filed: Jan. 8, 2025

(30) Foreign Application Priority Data
Aug. 14, 2024 (CN) 202411116551.4

(51) Int. Cl. H05B 45/3725; H05B 45/325; H05B 47/17

(52) U.S. Cl. CPC H05B 45/3725; H05B 45/325; H05B 47/17

(57) ABSTRACT

A lighting device driver includes an input module, a rectification module, a driving control module and a power conversion module. The input module couples an input signal. The rectification module is connected to the input module, and rectifies the input signal to generate a rectified signal. The driving control module is connected to the rectification module, and includes a control unit and a signal identification unit connected to each other, A portion of the input signal is coupled to the signal identification unit, causing the signal identification unit to generate an identification signal. The power conversion module is connected to the driving control module, the control unit, and a load. The rectified signal drives the load via the driving control module and the power conversion module, and the control unit controls the power conversion module to switch the operating mode thereof according to the frequency of the identification signal.

### BACKGROUND OF THE INVENTION

### 1. Field of the Invention

The present invention relates to a lighting device driver, in particular to a highly compatible lighting device driver.

### 2. Description of the Prior Art

With advancements in technology, the functionality and efficiency of light tubes have significantly improved. To achieve compatibility with both utility power and ballast, multifunctional light tubes have been developed and are now widely used in the market.

Although currently available light tubes compatible with both utility power and ballasts offer great convenience, their circuit structures are complex, leading to significantly higher costs. For the same reason, the complex circuit structures of these light tubes require additional circuit modules and more electronic components. Consequently, these light tubes demand larger internal space, so the size of these light tube cannot be reduced.

### SUMMARY OF THE INVENTION

One embodiment of the present invention provides a highly compatible lighting device driver, which includes an input module, a rectification module, a driving control module and a power conversion module. The input module couples an input signal. The rectification module is connected to the input module, and rectifies the input signal to generate a rectified signal. The driving control module is connected to the rectification module, and includes a control unit and a signal identification unit connected to each other, A portion of the input signal is coupled to the signal identification unit, causing the signal identification unit to generate an identification signal. The power conversion module is connected to the driving control module, the control unit, and a load. The rectified signal drives the load via the driving control module and the power conversion module, and the control unit controls the power conversion module to switch the operating mode thereof according to the frequency of the identification signal.

In one embodiment, the control unit enters a ballast mode when the frequency of the identification signal is greater than or equal to a preset frequency threshold. The control unit, in the ballast mode, generates a direct-current signal to control the switch of the power conversion module to remain fully conductive.

In one embodiment, the power conversion module includes a switch unit, an output unit, and a sampling unit. The switch unit is connected to the output unit and the sampling unit, and the sampling unit is connected to the control unit. The rectified signal drives the load after being further smoothed via the switching unit, the output unit, and the sampling unit.

In one embodiment, the control unit enters a utility power mode when a frequency of the identification signal is lower than a preset frequency threshold. The control unit, in the utility power mode, generates a pulse-width modulation signal to control the power conversion module for power conversion.

In one embodiment, the power conversion module includes a switch unit, an output unit, and a sampling unit. The switch unit is connected to the output unit and the sampling unit, and the sampling unit is connected to the control unit. The rectified signal drives the load via the switch unit, the output unit, and the sampling unit. The sampling unit generates a feedback signal according to the peak current during the conduction of the switch unit, and the control unit adjusts the pulse-width modulation signal according to the feedback signal.

In one embodiment, the driving control module further includes an impedance identification and detection unit connected to the rectified signal output terminal of the rectification module and the control unit. The impedance identification and detection unit detects the impedance of the rectified signal, and the control unit enters a protection state when the impedance exceeds a preset impedance threshold.

In one embodiment, the impedance identification and detection unit includes a plurality of resistors connected to each other in series.

In one embodiment, the driving control module further includes a direct-current signal smoothing unit connected to the rectified signal output terminal of the rectification module and the control unit. The direct-current signal smoothing unit converts the rectified signal into a smoothed direct-current signal to supply power to the driving control module.

In one embodiment, the signal identification unit is a capacitor.

In one embodiment, the signal identification unit is connected to the input module via another capacitor, such that the portion of the input signal is coupled to the signal identification unit.

The highly compatible lighting device driver in accordance with the embodiments of the present invention may have the following advantages:
(1) In one embodiment of the present invention, the lighting device driver includes an input module, a rectification module, a driving control module and a power conversion module. The input module couples an input signal. The rectification module is connected to the input module, and rectifies the input signal to generate a rectified signal. The driving control module is connected to the rectification module, and includes a control unit and a signal identification unit connected to each other, A portion of the input signal is coupled to the signal identification unit, causing the signal identification unit to generate an identification signal. The power conversion module is connected to the driving control module, the control unit, and a load. The rectified signal drives the load via the driving control module and the power conversion module, and the control unit controls the power conversion module to switch the operating mode thereof according to the frequency of the identification signal. The control unit enters a ballast mode when the frequency of the identification signal is greater than or equal to a preset frequency threshold. The control unit, in the ballast mode, generates a direct-current signal to control the switch of the power conversion module to remain fully conductive. The control unit enters a utility power mode when a frequency of the identification signal is lower than a preset frequency threshold. The control unit, in the utility power mode, generates a pulse-width modulation signal to control the power conversion module for power conversion. Via the above control mechanism based on input signal identification, the lighting device driver can selectively output either a direct-current signal or a pulse-width modulation signal to switch between the utility power mode and the ballast mode. Thus, the lighting device driver achieves high compatibility, so the lighting device driver can be more comprehensive in application.
(2) In one embodiment of the invention, the lighting device driver achieves high compatibility through the above control mechanism based on input signal identification without requiring additional circuit modules. Furthermore, the circuit structure of the lighting device driver can simultaneously support the utility power mode and the ballast mode. As a result, the circuit structure of the lighting device driver can be significantly simplified, substantially reducing the cost of the lighting device driver. Therefore, the lighting device driver meets actual requirements.
(3) In one embodiment of the invention, the lighting device driver achieves high compatibility through the above control mechanism based on input signal identification without requiring additional circuit modules. As a result, the circuit structure of the lighting device driver can be significantly simplified, reducing the number of electronic components required. Therefore, the size of the lighting device driver can be reduced to achieve miniaturization, aligning with future development trends.
(4) In one embodiment of the invention, the driving control module of the lighting device driver further includes an impedance identification and detection unit. The impedance identification and detection unit is connected to the rectified signal output terminal of the rectification module and the control unit. It detects the impedance of the rectified signal, and the control unit enters a protection state when the impedance exceeds the preset impedance threshold. The above impedance detection mechanism effectively detects whether a human body resistance is connected to the lighting device driver, preventing electric shock. Thus, the safety performance of the lighting device driver is significantly improved.
(5) In one embodiment of the invention, the lighting device driver features a simple circuit design, allowing it to achieve the desired functionality while reducing costs. Moreover, the circuit design of the lighting device driver enables a smaller size, meeting the demands of high practicality for various applications.

Further scope of applicability of the present application will become more apparent from the detailed description given hereinafter. However, it should be understood that the detailed description and specific examples, while indicating exemplary embodiments of the present invention, are given by way of illustration only, since various changes and modifications within the spirit and scope of the present invention will become apparent to those skilled in the art from this detailed description.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is the block diagram of the highly compatible lighting device driver in accordance with the first embodiment of the present invention.

FIG. 2 is the circuit diagram of the highly compatible lighting device driver in accordance with the second embodiment of the present invention.

FIG. 3 is the schematic view of the highly compatible lighting device driver operating in the utility power mode in accordance with the second embodiment of the present invention.

FIG. 4 is the schematic view of the pulse-width modulation signal of the highly compatible lighting device driver in accordance with the second embodiment of the present invention.

FIG. 5 is the schematic view of the highly compatible lighting device driver operating in the ballast mode in accordance with the second embodiment of the present invention.

FIG. 6 is the schematic view of the direct-current signal of the highly compatible lighting device driver in accordance with the second embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

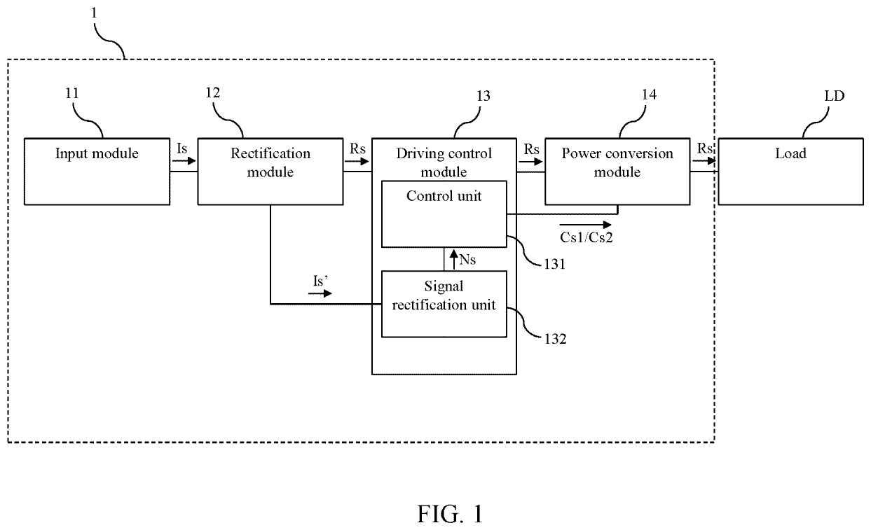

Please refer to FIG. 1, which is the block diagram of the highly compatible lighting device driver in accordance with the first embodiment of the present invention. As shown in FIG. 1, the lighting device driver 1 includes an input module 11, a rectification module 12, a driving control module 13, and a power conversion module 14.

The input module 11 is connected to an external power source to couple an input signal Is, which is outputted by the power source. The power source can be a utility power or a ballast GH.

The rectification module 12 is connected to the input module 11 and rectifies the input signal Is to generate a rectified signal Rs.

The driving control module 13 is connected to the rectification module 12, and includes a control unit 131 and a signal identification unit 132 connected to each other. The control unit 131 is connected to the rectification module 12, and the signal identification unit 132 is also connected to the rectification module 12, allowing a portion of the input signal Is′ to be coupled to the signal identification unit 132. Thus, the signal identification unit 132 can generate an identification signal Ns. In one embodiment, the control unit 131 can be a microcontroller (MCU). In another embodiment, the control unit 131 can be a central processing unit (CPU), an application-specific integrated circuit (ASIC), a field-programmable gate array (FPGA), or other similar components. The signal identification unit 132 can be a component with energy storage functionality. In one embodiment, the signal identification unit 132 is a capacitor Cp. The signal identification unit 132 can be connected to the input module 11 via another capacitor Cp (the capacitor Cp can be disposed within the rectification module 12, to couple a portion of the input signal Is′ to the signal identification unit 132. Alternatively, the signal identification unit 132 can be directly connected to the input module 11. In another embodiment, the signal identification unit 132 can be an inductor L1 or a circuit structure including multiple electronic components (such as capacitors Cp, inductors L1, and resistors). Additionally, the driving control module 13 can include an impedance identification and detection unit 133. The impedance identification and detection unit 133 is connected to the rectified signal output terminal VB+ of the rectification module 12 and the control unit 131. The impedance identification and detection unit 133 detects the impedance of the rectified signal Rs. The control unit 131 enters a protection state when the impedance exceeds the preset impedance threshold, thereby achieving an impedance detection mechanism. This mechanism effectively detects whether a human body resistance is connected to the lighting device driver 1, preventing electric shocks. Consequently, the safety performance of the lighting device driver 1 is significantly enhanced.

The power conversion module 14 is connected to the driving control module 13, the control unit 131, and the load LD. In one embodiment, the load LD can include one or more light sources LS, such as light-emitting diodes (LEDs). In another embodiment, the light source LS can also be a bulb, a tube light, or other similar components. The rectified signal Rs drives the load LD via the driving control module 13 and the power conversion module 14.

The control unit 131 controls the power conversion module 14 to switch the operating mode based on the frequency of the identification signal Ns. The control unit 131 enters the ballast mode when the frequency of the identification signal Ns is greater than or equal to the preset frequency threshold. In the ballast mode, the control unit 131 generates a direct-current signal Cs1 to control the power conversion module 14 to keep the switch of the power conversion module 14 fully conductive. Conversely, the control unit 131 enters the utility power mode when the frequency of the identification signal Ns is lower than the preset frequency threshold. In the utility power mode, the control unit 131 generates a pulse-width modulation signal Cs2 to control the power conversion module 14 for power conversion.

The above circuit structure implements a control mechanism based on input signal identification. Via this mechanism, the lighting device driver 1 can selectively output either the direct-current signal Cs1 or the pulse-width modulation signal Cs2 to switch between the utility power mode and the ballast mode. Therefore, the lighting device driver 1 achieves high compatibility, so the lighting device driver 1 can be more comprehensive in application.

In this embodiment, the lighting device driver 1 achieves high compatibility through the control mechanism based on input signal identification without requiring additional circuit modules. Furthermore, the circuit structure of the lighting device driver 1 can simultaneously support the utility power mode and the ballast mode. As a result, the circuit structure of the lighting device driver 1 can be significantly simplified, substantially reducing the cost thereof. Thus, the lighting device driver 1 can meet actual requirements.

Additionally, in this embodiment, the lighting device driver 1 achieves high compatibility through the control mechanism based on input signal identification without requiring additional circuit modules. As a result, the circuit structure of the lighting device driver 1 can be significantly simplified, reducing the number of electronic components required. Consequently, the size of the lighting device driver 1 can be reduced to achieve miniaturization, aligning with future development trends.

The embodiment just exemplifies the present invention and is not intended to limit the scope of the present invention; any equivalent modification and variation according to the spirit of the present invention is to be also included within the scope of the following claims and their equivalents.

The embodiment just exemplifies the present invention and is not intended to limit the scope of the present invention; any equivalent modification and variation according to the spirit of the present invention is to be also included within the scope of the following claims and their equivalents.

It is worthy to point out that currently available light tubes compatible with both utility power and ballasts can offer great convenience, but their circuit structures are complex, leading to significantly higher costs. For the same reason, the complex circuit structures of these light tubes require additional circuit modules and more electronic components. Consequently, these light tubes demand larger internal space, so the size of these light tube cannot be reduced. By contrast, according to one embodiment of the invention, the lighting device driver includes an input module, a rectification module, a driving control module and a power conversion module. The input module couples an input signal. The rectification module is connected to the input module, and rectifies the input signal to generate a rectified signal. The driving control module is connected to the rectification module, and includes a control unit and a signal identification unit connected to each other, A portion of the input signal is coupled to the signal identification unit, causing the signal identification unit to generate an identification signal. The power conversion module is connected to the driving control module, the control unit, and a load. The rectified signal drives the load via the driving control module and the power conversion module, and the control unit controls the power conversion module to switch the operating mode thereof according to the frequency of the identification signal. The control unit enters a ballast mode when the frequency of the identification signal is greater than or equal to a preset frequency threshold. The control unit, in the ballast mode, generates a direct-current signal to control the switch of the power conversion module to remain fully conductive. The control unit enters a utility power mode when a frequency of the identification signal is lower than a preset frequency threshold. The control unit, in the utility power mode, generates a pulse-width modulation signal to control the power conversion module for power conversion. Via the above control mechanism based on input signal identification, the lighting device driver can selectively output either a direct-current signal or a pulse-width modulation signal to switch between the utility power mode and the ballast mode. Thus, the lighting device driver achieves high compatibility, so the lighting device driver can be more comprehensive in application.

Also, according to one embodiment of the invention, the lighting device driver achieves high compatibility through the above control mechanism based on input signal identification without requiring additional circuit modules. Furthermore, the circuit structure of the lighting device driver can simultaneously support the utility power mode and the ballast mode. As a result, the circuit structure of the lighting device driver can be significantly simplified, substantially reducing the cost of the lighting device driver. Therefore, the lighting device driver meets actual requirements.

Further, according to one embodiment of the invention, the lighting device driver achieves high compatibility through the above control mechanism based on input signal identification without requiring additional circuit modules. As a result, the circuit structure of the lighting device driver can be significantly simplified, reducing the number of electronic components required. Therefore, the size of the lighting device driver can be reduced to achieve miniaturization, aligning with future development trends.

Moreover, according to one embodiment of the invention, the driving control module of the lighting device driver further includes an impedance identification and detection unit. The impedance identification and detection unit is connected to the rectified signal output terminal of the rectification module and the control unit. It detects the impedance of the rectified signal, and the control unit enters a protection state when the impedance exceeds the preset impedance threshold. The above impedance detection mechanism effectively detects whether a human body resistance is connected to the lighting device driver, preventing electric shock. Thus, the safety performance of the lighting device driver is significantly improved.

Furthermore, according to one embodiment of the invention, the lighting device driver features a simple circuit design, allowing it to achieve the desired functionality while reducing costs. Moreover, the circuit design of the lighting device driver enables a smaller size, meeting the demands of high practicality for various applications. As set forth above, the highly compatible lighting device driver according to the embodiments of the present invention can achieve great technical effects.

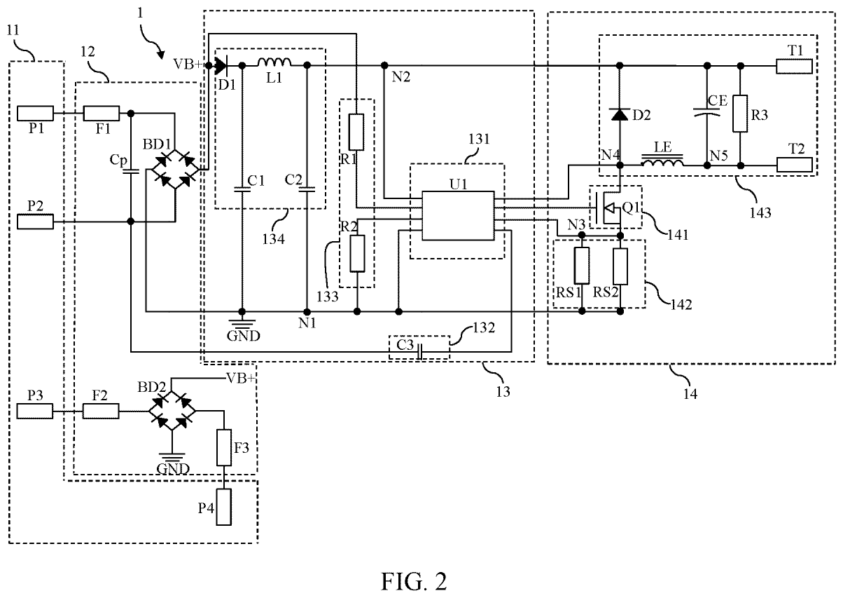

Please refer to FIG. 2, which is the circuit diagram of the highly compatible lighting device driver in accordance with the second embodiment of the present invention. Please also refer to FIG. 1. FIG. 2 illustrates the circuit structure of the lighting device driver 1. This embodiment is for illustration purposes only; the circuit structures of the input module 11, rectification module 12, driving control module 13, and power conversion module 14 may vary according to actual needs. As shown in FIG. 2, the lighting device driver 1 includes an input module 11, a rectification module 12, a driving control module 13, and a power conversion module 14.

The input module 11 includes a first input terminal P1, a second input terminal P2, a third input terminal P3, and a fourth input terminal P4.

The rectification module 12 is connected to the input module 11. The rectification module 12 includes a first rectifier BD1, a second rectifier BD2, a first fuse F1, a second fuse F2, a third fuse F3, and a capacitor Cp. The first end of the first rectifier BD1 is connected to the second input terminal P2. The second end of the first rectifier BD1 is connected to the rectified signal output terminal VB+. The third end of the first rectifier BD1 is connected to the first input terminal P1 via the first fuse F1. The fourth end of the first rectifier BD1 is connected to the first node N1. The first node N1 is connected to the ground GND. The first end of the second rectifier BD2 is connected to the fourth input terminal P4 through the third fuse F3. The second end of the second rectifier BD2 is connected to the rectified signal output terminal VB+. The third end of the second rectifier BD2 is connected to the third input terminal P3 via the second fuse F2. The fourth end of the second rectifier BD2 is connected to the ground GND. In one embodiment, the first rectifier BD1 and the second rectifier BD2 can be bridge rectifiers (full-wave rectifiers or half-wave rectifiers). In another embodiment, the first rectifier BD1 and the second rectifier BD2 can be bipolar junction transistors, circuits including transistors, or any existing circuits or electronic components with rectification functions.

The driving control module 13 is connected to the rectification module 12. The driving control module 13 includes a control unit 131, a signal identification unit 132, an impedance identification and detection unit 133, and a direct-current signal smoothing unit 134 connected to each other. The control unit 131 may have at least one signal identification interface, which is connected to the signal identification unit 132 via this interface. The direct-current signal smoothing unit 134 includes a first diode D1, an inductor L1, a first capacitor C1, and a second capacitor C2. The anode of the first diode D1 is connected to the rectified signal output terminal VB+, and the cathode is connected to one end of the inductor L1. The other end of the inductor L1 is connected to the second node N2 and to the ground GND via the second capacitor C2. The impedance identification and detection unit 133 includes a plurality of resistors connected in series. In this embodiment, the impedance identification and detection unit 133 includes a first resistor R1 and a second resistor R2. The two ends of the first resistor R1 are connected to the rectified signal output terminal VB+ and the control unit 131, respectively. The two ends of the second resistor R2 are connected to the control unit 131 and the first node N1, respectively. The signal identification unit 132 includes a third capacitor C3, which is connected to the first input terminal P1 through the capacitor Cp, allowing a portion of the input signal Is′ to be coupled to the third capacitor C3 (signal identification unit 132). The control unit 131 includes a controller U1, which can be but is not limited to a microcontroller.

The power conversion module 14 is connected to the control unit 131. The power conversion module 14 includes a switch unit 141, an output unit 143, and a sampling unit 142. The sampling unit 142 includes a first sampling resistor RS1 and a second sampling resistor RS2 connected in parallel. One end of the first sampling resistor RS1 is connected to the first node N1, and the other end thereof is connected to the third node N3. The switch unit 141 includes a switch Q1, which may be a metal-oxide-semiconductor field-effect transistor. In another embodiment, the switch Q1 may also be a bipolar junction transistor or other similar components. The first end of the switch Q1 is connected to the control unit 131, the second end thereof is connected to the third node N3, and the third thereof is connected to the fourth node N4. The third node N3 and the fourth node N4 are both connected to the control unit 131. The output unit 143 includes a second diode D2, an energy storage inductor LE, an electrolytic capacitor CE, a third resistor R3, a first output terminal T1, and a second output terminal T2. The anode and cathode of the second diode D2 are connected to the fourth node N4 and the second node N2, respectively. The two ends of the energy storage inductor LE are connected to the fourth node N4 and the fifth node N5, respectively. The two ends of the electrolytic capacitor CE are connected to the fifth node N5 and the second node N2, respectively. The two ends of the third resistor R3 are connected to the fifth node N5 and the second node N2, respectively. The second node N2 and the fifth node N5 are connected to the first output terminal T1 and the second output terminal T2, respectively.

The embodiment just exemplifies the present invention and is not intended to limit the scope of the present invention; any equivalent modification and variation according to the spirit of the present invention is to be also included within the scope of the following claims and their equivalents.

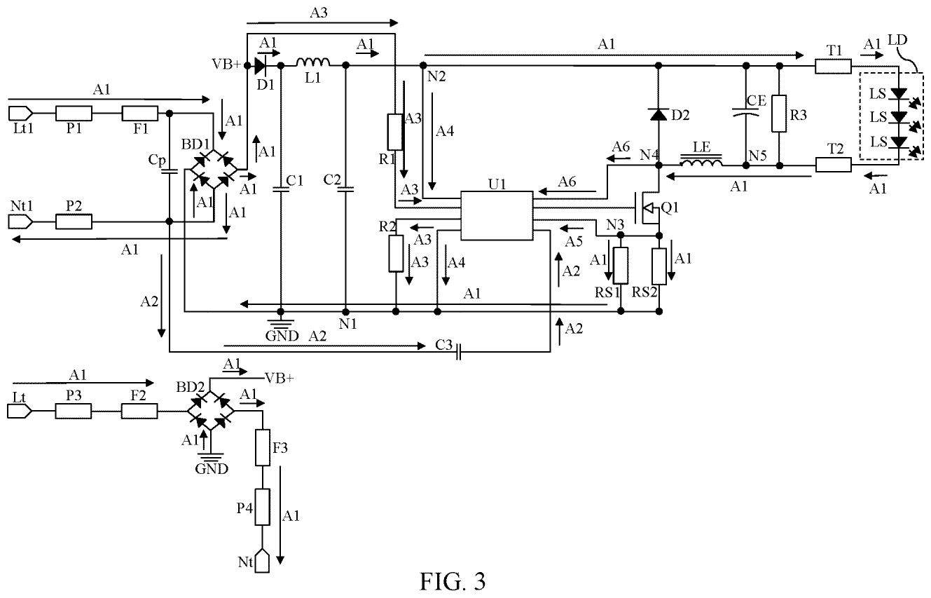

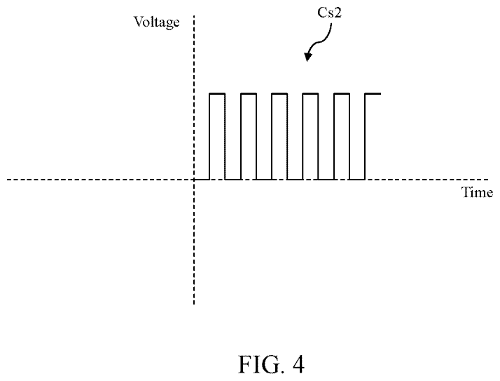

Please refer to FIG. 3 and FIG. 4. Please also refer to FIG. 1 and FIG. 2. FIG. 3 is the schematic view of the highly compatible lighting device driver operating in the utility power mode in accordance with the second embodiment of the present invention. FIG. 4 is the schematic view of the pulse-width modulation signal of the highly compatible lighting device driver in accordance with the second embodiment of the present invention. As shown FIG. 3 and FIG. 4, the load LD includes a plurality of light sources LS, which can be light-emitting diodes. The load LD is connected to the first output terminal T1 and the second output terminal T2 of the output unit 143. When the input module 11 is connected to the utility power (Lt1, Nt1, Lt, and Nt represent the output terminals of the utility power), the input module 11 couples the input signal Is, and the rectification module 12 rectifies the input signal Is to generate the rectified signal Rs. Then, a portion of the input signal Is′ is coupled to the signal identification unit 132 via the capacitor Cp of the rectification module 12, allowing the signal identification unit 132 to generate the identification signal Ns, as indicated by the arrow A2. When the frequency of the identification signal Ns is lower than the preset frequency threshold (which may be but is not limited to 22 kHz and can be adjusted based on actual needs), the control unit 131 enters the utility power mode. In this mode, the control unit 131 generates a pulse-width modulation signal Cs2 (as shown in FIG. 4) to control the power conversion module 14 for power conversion. In this case, the switch unit 141 is continuously turned on and off, enabling the power conversion module 14 to perform power conversion. The impedance identification and detection unit 133 of the driving control module 13 detects the impedance of the rectified signal Rs, as indicated by the arrow A3. If the impedance exceeds the preset impedance threshold (which may be but is not limited to 400 ohms and can be adjusted based on actual needs), the control unit 131 enters the protection state. This condition indicates that a human body resistance may be connected to the lighting device driver 1, causing the control unit 131 to stop sending signals to the switch unit 141 of the power conversion module 14. The direct-current signal smoothing unit 134 converts the rectified signal Rs into a smoothed direct-current signal Cs1 to power the driving control module 13, as indicated by the arrow A4. The sampling unit 142 of the power conversion module 14 generates a feedback signal based on the peak current when the switch unit 141 is turned on, and the control unit 131 adjusts the pulse-width modulation signal Cs2 based on the feedback signal, as indicated by the arrow A5. The control unit 131 can also receive a zero-crossing detection signal from the fourth node N4 to perform zero-crossing detection, as indicated by the arrow A6. The rectified signal Rs drives the load LD via the power conversion module 14 (the switch unit 141, the output unit 143, and the sampling unit 142). The path of the rectified signal Rs is shown as the arrow A1.

The embodiment just exemplifies the present invention and is not intended to limit the scope of the present invention; any equivalent modification and variation according to the spirit of the present invention is to be also included within the scope of the following claims and their equivalents.

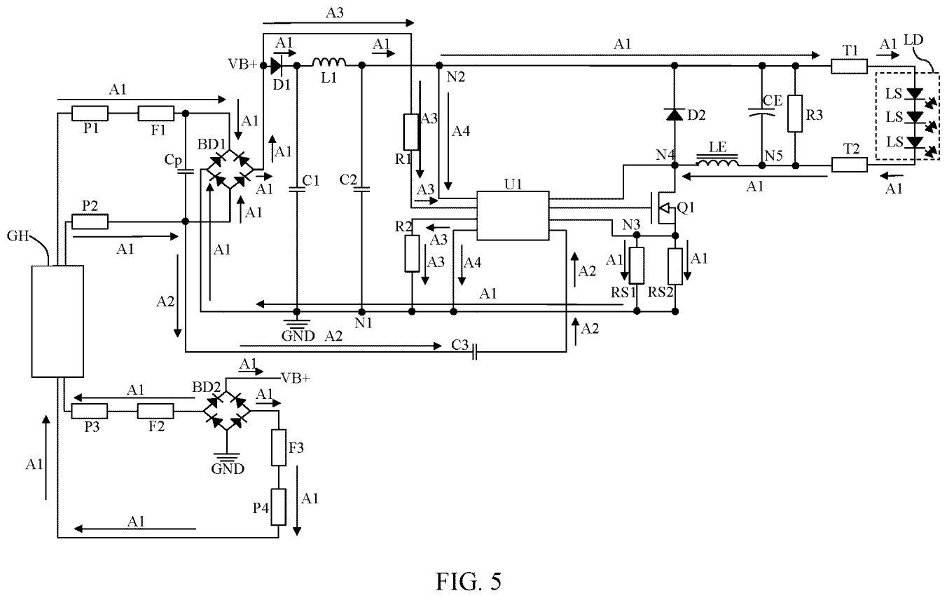

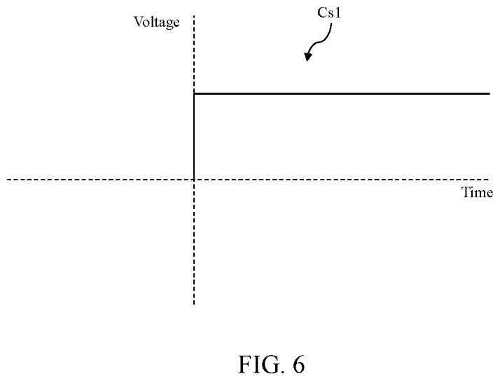

Please refer to FIG. 5 and FIG. 6. Please also refer to FIG. 1 and FIG. 2. FIG. 5 is the schematic view of the highly compatible lighting device driver operating in the ballast mode in accordance with the second embodiment of the present invention. FIG. 6 is the schematic view of the direct-current signal of the highly compatible lighting device driver in accordance with the second embodiment of the present invention.

As shown in FIG. 5 and FIG. 6, the load LD includes a plurality of light sources LS, which may be light-emitting diodes. The load LD is connected to the first output terminal T1 and the second output terminal T2 of the output unit 143. When the input module 11 is connected to the ballast GH, the input module 11 generates an input signal Is. The rectification module 12 rectifies the input signal Is to produce a rectified signal Rs. Subsequently, a portion of the input signal Is′, through the capacitor Cp of the rectification module 12, is coupled to the signal identification unit 132, enabling the signal identification unit 132 to generate an identification signal Ns, as indicated by the arrow A2.

When the frequency of the identification signal Ns exceeds the preset frequency threshold (which can be, but is not limited to, 22 kHz and may be adjusted as needed), the control unit 131 enters the ballast mode. In this mode, the control unit 131 generates the direct-current signal Cs1 (as shown in FIG. 6) to control the continuous conduction of the switch of the power conversion module 14. Under these circumstances, the switch unit 141 can maintain a continuously conductive state to form a closed loop. In this way, the rectified signal Rs, generated after rectifying the signal input from the ballast GH, can directly drive the load LD. The impedance identification and detection unit 133 of the driving control module 13 detects the impedance of the rectified signal Rs, as indicated by the arrow A3. When the impedance exceeds the preset impedance threshold (which can be, but is not limited to, 400 ohms and may be adjusted as needed), the control unit 131 enters a protection state. This condition indicates the possible connection of a human resistance to the lighting device driver 1, prompting the control unit 131 to shut down or cease sending signals to the switch unit 141 of the power conversion module 14. The direct-current signal smoothing unit 134 converts the rectified signal Rs into a smoothed direct-current signal Cs1 to supply power to the driving control module 13, as indicated by the arrow A4. After being further smoothed via the power conversion module 14 (including the switch unit 141, the output unit 143, and the sampling unit 142), the rectified signal Rs drives the load LD. The path of the rectified signal Rs is illustrated by arrow A1 in the figure.

As previously stated, via the input signal identification-based control mechanism, the lighting device driver 1 can selectively output the direct-current signal Cs1 or the pulse-width modulation signal Cs2 to switch between the utility power mode and the ballast mode. Therefore, the lighting device driver 1 achieves high compatibility, so the lighting device driver 1 can be more comprehensive in application.

Additionally, in this embodiment, the lighting device driver 1 achieves high compatibility through the aforementioned input signal identification-based control mechanism without requiring additional circuit modules. Furthermore, the circuit structure of the lighting device driver 1 can simultaneously realize both the utility power mode and the ballast mode. As a result, the circuit structure of the lighting device driver 1 can be greatly simplified, significantly reducing the cost of the lighting device driver 1. Thus, the lighting device driver 1 meets actual requirements.

Moreover, in this embodiment, the lighting device driver 1 achieves high compatibility through the above control mechanism based on input signal identification without requiring additional circuit modules. This simplification in the circuit structure reduces the number of electronic components needed for the lighting device driver 1, thereby minimizing its size. This enables the lighting device driver 1 to meet the trend toward miniaturization in future developments.

Additionally, in this embodiment, the driving control module 13 of the lighting device driver 1 also includes the impedance identification and detection unit 133. The impedance identification and detection unit 133 is connected to the rectified signal output terminal VB+ of the rectification module 12 and the control unit 131. The impedance identification and detection unit 133 detects the impedance of the rectified signal Rs. When the impedance exceeds the preset impedance threshold, the control unit 131 enters a protection state. This impedance detection mechanism effectively detects whether human resistance is connected to the lighting device driver 1, thereby preventing electric shock incidents. As a result, the safety performance of the lighting device driver 1 is significantly enhanced.

The embodiment just exemplifies the present invention and is not intended to limit the scope of the present invention; any equivalent modification and variation according to the spirit of the present invention is to be also included within the scope of the following claims and their equivalents.

To sum up, according to one embodiment of the invention, the lighting device driver includes an input module, a rectification module, a driving control module and a power conversion module. The input module couples an input signal. The rectification module is connected to the input module, and rectifies the input signal to generate a rectified signal. The driving control module is connected to the rectification module, and includes a control unit and a signal identification unit connected to each other, A portion of the input signal is coupled to the signal identification unit, causing the signal identification unit to generate an identification signal. The power conversion module is connected to the driving control module, the control unit, and a load. The rectified signal drives the load via the driving control module and the power conversion module, and the control unit controls the power conversion module to switch the operating mode thereof according to the frequency of the identification signal. The control unit enters a ballast mode when the frequency of the identification signal is greater than or equal to a preset frequency threshold. The control unit, in the ballast mode, generates a direct-current signal to control the switch of the power conversion module to remain fully conductive. The control unit enters a utility power mode when a frequency of the identification signal is lower than a preset frequency threshold. The control unit, in the utility power mode, generates a pulse-width modulation signal to control the power conversion module for power conversion. Via the above control mechanism based on input signal identification, the lighting device driver can selectively output either a direct-current signal or a pulse-width modulation signal to switch between the utility power mode and the ballast mode. Thus, the lighting device driver achieves high compatibility, so the lighting device driver can be more comprehensive in application.

Also, according to one embodiment of the invention, the lighting device driver achieves high compatibility through the above control mechanism based on input signal identification without requiring additional circuit modules. Furthermore, the circuit structure of the lighting device driver can simultaneously support the utility power mode and the ballast mode. As a result, the circuit structure of the lighting device driver can be significantly simplified, substantially reducing the cost of the lighting device driver. Therefore, the lighting device driver meets actual requirements.

Further, according to one embodiment of the invention, the lighting device driver achieves high compatibility through the above control mechanism based on input signal identification without requiring additional circuit modules. As a result, the circuit structure of the lighting device driver can be significantly simplified, reducing the number of electronic components required. Therefore, the size of the lighting device driver can be reduced to achieve miniaturization, aligning with future development trends.

Moreover, according to one embodiment of the invention, the driving control module of the lighting device driver further includes an impedance identification and detection unit. The impedance identification and detection unit is connected to the rectified signal output terminal of the rectification module and the control unit. It detects the impedance of the rectified signal, and the control unit enters a protection state when the impedance exceeds the preset impedance threshold. The above impedance detection mechanism effectively detects whether a human body resistance is connected to the lighting device driver, preventing electric shock. Thus, the safety performance of the lighting device driver is significantly improved.

Furthermore, according to one embodiment of the invention, the lighting device driver features a simple circuit design, allowing it to achieve the desired functionality while reducing costs. Moreover, the circuit design of the lighting device driver enables a smaller size, meeting the demands of high practicality for various applications.

It will be apparent to those skilled in the art that various modifications and variations can be made to the disclosed embodiments. It is intended that the specification and examples be considered as exemplary only, with a true scope of the present invention being indicated by the following claims and their equivalents.

Those skilled in the art will readily observe that numerous modifications and alterations of the device and method may be made while retaining the teachings of the invention.

Accordingly, the above disclosure should be construed as limited only by the metes and bounds of the appended claims.

What is claimed is:

1. A highly compatible lighting device driver, comprising:
an input module configured to couple an input signal;
a rectification module connected to the input module, and configured to rectify the input signal to generate a rectified signal;
a driving control module connected to the rectification module, and comprising a control unit and a signal identification unit connected to each other, wherein a portion of the input signal is coupled to the signal identification unit, causing the signal identification unit to generate an identification signal; and
a power conversion module connected to the driving control module, the control unit, and a load;
wherein the rectified signal drives the load via the driving control module and the power conversion module, and the control unit controls the power conversion module to switch an operating mode thereof according to a frequency of the identification signal.

2. The highly compatible lighting device driver as claimed in claim 1, wherein the control unit enters a ballast mode when the frequency of the identification signal is greater than or equal to a preset frequency threshold, wherein the control unit, in the ballast mode, generates a direct-current signal to control a switch of the power conversion module to remain fully conductive.

3. The highly compatible lighting device driver as claimed in claim 2, wherein the power conversion module comprises a switch unit, an output unit, and a sampling unit, wherein the switch unit is connected to the output unit and the sampling unit, and the sampling unit is connected to the control unit, wherein the rectified signal drives the load after being smoothed via the switching unit, the output unit, and the sampling unit.

4. The highly compatible lighting device driver as claimed in claim 1, wherein the control unit enters a utility power mode when a frequency of the identification signal is lower than a preset frequency threshold, wherein the control unit, in the utility power mode, generates a pulse-width modulation signal to control the power conversion module for power conversion.

5. The highly compatible lighting device driver as claimed in claim 4, wherein the power conversion module comprises a switch unit, an output unit, and a sampling unit, wherein the switch unit is connected to the output unit and the sampling unit, and the sampling unit is connected to the control unit, wherein the rectified signal drives the load via the switch unit, the output unit, and the sampling unit, wherein the sampling unit generates a feedback signal according to a peak current during a conduction of the switch unit, and the control unit adjusts the pulse-width modulation signal according to the feedback signal.

6. The highly compatible lighting device driver as claimed in claim 1, wherein the driving control module further comprises an impedance identification and detection unit connected to a rectified signal output terminal of the rectification module and the control unit, wherein the impedance identification and detection unit detects an impedance of the rectified signal, and the control unit enters a protection state when the impedance exceeds a preset impedance threshold.

7. The highly compatible lighting device driver as claimed in claim 6, wherein the impedance identification and detection unit comprises a plurality of resistors connected to each other in series.

8. The highly compatible lighting device driver as claimed in claim 1, wherein the driving control module further comprises a direct-current signal smoothing unit connected to a rectified signal output terminal of the rectification module and the control unit, wherein the direct-current signal smoothing unit converts the rectified signal into a smoothed direct-current signal to supply power to the driving control module.

9. The highly compatible lighting device driver as claimed in claim 1, wherein the signal identification unit is a capacitor.

10. The highly compatible lighting device driver as claimed in claim 9, wherein the signal identification unit is connected to the input module via another capacitor, whereby the portion of the input signal is coupled to the signal identification unit.
